(19) United States
(12) Patent Application Publication
(10) Pub. No.: US 2018/0366055 A1
(43) Pub. Date: Dec. 20, 2018

(54) METHOD OF COMPRESSING IMAGE AND DISPLAY APPARATUS FOR PERFORMING THE SAME

(71) Applicants: Samsung Display Co., Ltd., Yongin-Si (KR); Kwangwoon University Industry-Academic Collaboration Foundation, Seoul (KR)

(72) Inventors: KITAE YOON, Seoul (KR); JAEHYOUNG PARK, Suwon-si (KR); YONGJO AHN, Seoul (KR)

(21) Appl. No.: 15/939,728

(22) Filed: Mar. 29, 2018

(30) Foreign Application Priority Data
Jun. 14, 2017 (KR) 10-2017-0075133

(51) Int. Cl. G09G 3/20; H04N 19/625; H04N 19/176

(52) U.S. Cl. CPC G09G 3/2096; H04N 19/625; G09G 2320/0252; G09G 2340/02; H04N 19/176

(57) ABSTRACT

A method of compressing image data in a display apparatus in a unit of block including a plurality of pixels includes generating a residual signal by predicting image data of a plurality of second blocks disposed in a second horizontal line using image data of a plurality of first blocks disposed in a first horizontal line, where the second horizontal line is disposed under the first horizontal line, determining whether operating discrete cosine transform (“DCT”) to the residual signal or not based on an input image, compressing the image data of the second blocks and determining compressibility of image data of a plurality of third blocks disposed in a third horizontal line disposed under the second horizontal line based on compressibility of the image data of the second blocks.

This application claims priority to Korean Patent Application No. 10-2017-0075133, filed on Jun. 14, 2017, and all the benefits accruing therefrom under 35 U.S.C. § 119, the content of which in its entirety is herein incorporated by reference.

### BACKGROUND

### 1. Field

Exemplary embodiments of the invention relate to a display apparatus. More particularly, exemplary embodiments of the invention relate to a method of compressing an image performed by a display apparatus and the display apparatus that performs the method.

### 2. Description of the Related Art

A display apparatus, such as a liquid crystal display (“LCD”) apparatus and an organic light emitting diode (“OLED”) display apparatus, typically includes a display panel and a display panel driver. The display panel includes a plurality of gate lines, a plurality of data lines and a plurality of pixels connected to the gate lines and the data lines. The display panel driver includes a gate driver for providing gate signals to the gate lines and a data driver for providing data voltages to the data lines.

To increase speed of response of the LCD apparatus, a dynamic capacitance compensation (“DCC”) method may be applied to the LCD apparatus. In the DCC method, grayscales of present frame image data are compensated based on previous frame image data and the present frame image data. To operate the DCC method, the LCD apparatus may further include a memory to store the previous frame image data so that the size of the LCD apparatus and a manufacturing cost of the LCD apparatus may be increased.

Image compression method may be operated to reduce the size of the image data so that the data may be efficiently transferred and stored. For example, an unnecessary portion and a redundant portion may be reduced or omitted to reduce the size of the image data.

### SUMMARY INVENTION

Exemplary embodiments of the invention provide a method of compressing an image to improve a display quality.

Exemplary embodiments of the invention also provide a display apparatus that performs the method of compressing an image.

In an exemplary embodiment of a method of compressing image data in a display apparatus in a unit of block including a plurality of pixels, according to the invention, the method includes generating a residual signal by predicting image data of a plurality of second blocks disposed in a second horizontal line using image data of a plurality of first blocks disposed in a first horizontal line, where the second horizontal line is disposed under the first horizontal line, determining whether operating discrete cosine transform (“DCT”) to the residual signal or not based on an input image, compressing the image data of the second blocks, and determining compressibility of image data of a plurality of third blocks disposed in a third horizontal line disposed under the second horizontal line based on compressibility of the image data of the second blocks.

In an exemplary embodiment, the generating the residual signal by predicting the image data of the second blocks may include predicting the image data of the second blocks using image data of a plurality of reference pixels, wherein the pixels in a lowest line of the first blocks define the reference pixels, and generating the residual signal based on difference of the predicted image data of the second blocks and the image data of the second blocks.

In an exemplary embodiment, the reference pixels may be the pixels disposed in the lowest line of a first upper block and in the lowest line a first upper left block among the first blocks. In such an embodiment, the first upper block may be a first block adjacent to the second block in an upper direction and the first upper left block may be disposed at a left side of the first upper block.

In an exemplary embodiment, the predicting the image data of the second blocks using the image data of the reference pixels may include using an average of the image data of the reference pixels.

In an exemplary embodiment, the predicting the image data of the second blocks using the image data of the reference pixels may include predicting the image data of the pixels of the second block, which is disposed in a diagonal line to a right and lower direction from the reference pixels, as the image data of the corresponding reference pixels.

In an exemplary embodiment, the reference pixels may be the pixels disposed in the lowest line of a first upper block and in the lowest line of a first upper right block among the first blocks. In such an embodiment, the first upper block may be a first block adjacent to the second block in an upper direction and the first upper right block may a first block disposed at a right side of the first upper block. In such an embodiment, the predicting the image data of the second blocks may include predicting the image data of the pixels of the second block, which is disposed in a diagonal line to a left and lower direction from the reference pixels, as the image data of the reference pixels.

In an exemplary embodiment, the reference pixels may be the pixels disposed in the lowest line of a first upper block. In such an embodiment, the first upper block may be adjacent to a second block in an upper direction. In such an embodiment, the predicting the image data of the second blocks may include predicting the image data of the pixels of the second block, which is disposed in a lower direction from the reference pixels, as the image data of the corresponding reference pixels.

In an exemplary embodiment, the determining whether operating the DCT to the residual signal or not may include skipping the DCT when the input image includes a specific pattern and operating the DCT when the input image does not include the specific pattern.

In an exemplary embodiment, the compressing the image data of the second blocks may include quantizing the residual signal in a frequency domain when the DCT is operated and quantizing the residual signal in a time domain when the DCT is skipped

In an exemplary embodiment, the determining the compressibility of the image data of the third blocks may include comparing the compressibility of the image data of the second blocks to a target compressibility and determining the compressibility of the image data of the third blocks based on a result of the comparing.

In an exemplary embodiment, the determining the compressibility of the image data of the third blocks based on the result of the comparing may include decreasing the compressibility of the image data of the third blocks when the compressibility of the image data of the second blocks is greater than the target compressibility and increasing the compressibility of the image data of the third blocks when the compressibility of the image data of the second blocks is less than the target compressibility.

In an exemplary embodiment, the method may further include storing a parameter of the compressibility of the image data of the third blocks and the compressed image data of the second blocks to a memory.

In an exemplary embodiment, the compressing the image data of the second blocks may include quantizing the image data of the second blocks in a first quantizing coefficient. The parameter of the determined compressibility of the image data of the third blocks may be a difference of the first quantizing coefficient and a second quantizing coefficient to achieve the determined compressibility of the image data of the third blocks. In such an embodiment, the method may further include quantizing the image data of the third blocks in the second quantizing coefficient to compress the image data of the third blocks.

In an exemplary embodiment, each of the blocks may include the pixels disposed in 4 rows and 4 columns.

In an exemplary embodiment of a display apparatus according to the invention, the display apparatus includes a display panel and a driver. In such an embodiment, the display panel includes a plurality of gate lines extending in a horizontal direction, a plurality of data lines extending in a vertical direction crossing the horizontal direction and a plurality of blocks, where each of the blocks includes a plurality of pixels, and the display panel displays an image. In such an embodiment, the driver predicts image data of a plurality of second blocks disposed in a second horizontal line using image data of a plurality of first blocks disposed in a first horizontal line to generate a residual signal. In such an embodiment, the second horizontal line is disposed under the first horizontal line, and the driver determines whether operating DCT to the residual signal or not based on an input image, compresses the image data of the second blocks, and determines compressibility of image data of a plurality of third blocks disposed in a third horizontal line disposed under the second horizontal line based on compressibility of the image data of the second blocks.

In an exemplary embodiment, the driver may operate a dynamic capacitance compensation based on compressed previous frame image data and present frame image data to generate a present frame data signal. In such an embodiment, the display panel may display a present frame image based on the present frame data signal.

In an exemplary embodiment, the driver may predict the image data of the second blocks using image data of a plurality of reference pixels disposed lowest line of the first blocks, and generate the residual signal corresponding to difference of the predicted image data of the second blocks and the image data of the second blocks.

In an exemplary embodiment, the driver may skip the DCT when the input image includes a specific pattern, and operate the DCT when the input image does not include the specific pattern.

In an exemplary embodiment, the driver may compare the compressibility of the image data of the second blocks to a target compressibility, and determine the compressibility of the image data of the third blocks based on a result of comparing the compressibility of the image data of the second blocks to the target compressibility.

In an exemplary embodiment, the pixels in each of the blocks may be disposed in 4 rows and 4 columns.

According to exemplary embodiments of the method of compressing the image and the display apparatus that performs the method, the image data of the present block is predicted using the image data of the previous block, which are already encoded and compressed, such that the compressing efficiency may be increased in the limited hardware area. In such embodiments, when the input image includes a pattern improper to DCT, the DCT is omitted such that the compressibility may be increased. In such embodiments, the compressibility of the next block is controlled based on the compressibility of the present block such that the compressibility of the image may approach to the target compressibility. Thus, in such embodiments, the display quality of the display apparatus may be improved.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating a display apparatus according to an exemplary embodiment;

FIG. 2 is a block diagram illustrating an exemplary embodiment of a timing controller of FIG. 1;

FIG. 3 is a conceptual diagram illustrating frames of an image displayed on a display panel of FIG. 1;

FIG. 4 is a conceptual diagram illustrating a structure of pixels and blocks in a frame of the frames of FIG. 3;

FIG. 5 is a block diagram illustrating an exemplary embodiment of a data signal generator of the timing controller of FIG. 2;

FIG. 6 is a block diagram illustrating an exemplary embodiment of an encoder of the data signal generator of FIG. 5;

FIGS. 7A to 7D are conceptual diagrams illustrating an exemplary embodiment of a method of predicting image data operated by a predicting part of the encoder of FIG. 6;

FIG. 8A is a block diagram illustrating an exemplary embodiment of a converting part and a quantizing part of the encoder of FIG. 6;

FIG. 8B is a block diagram illustrating an exemplary embodiment of an inverse converting part and a dequantizing part of the encoder of FIG. 6;

FIGS. 9A to 9C are conceptual diagrams illustrating an exemplary embodiment of a method of controlling a compressibility operated by a compressibility control part of the encoder of FIG. 6;

FIG. 10 is a block diagram illustrating an exemplary embodiment of a decoder of the data signal generator of FIG. 5; and

FIG. 11 is a block diagram illustrating an alternative exemplary embodiment of a decoder of the data signal generator of FIG. 5.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Hereinafter, exemplary embodiments of the invention will be described in detail with reference to the accompanying drawings.

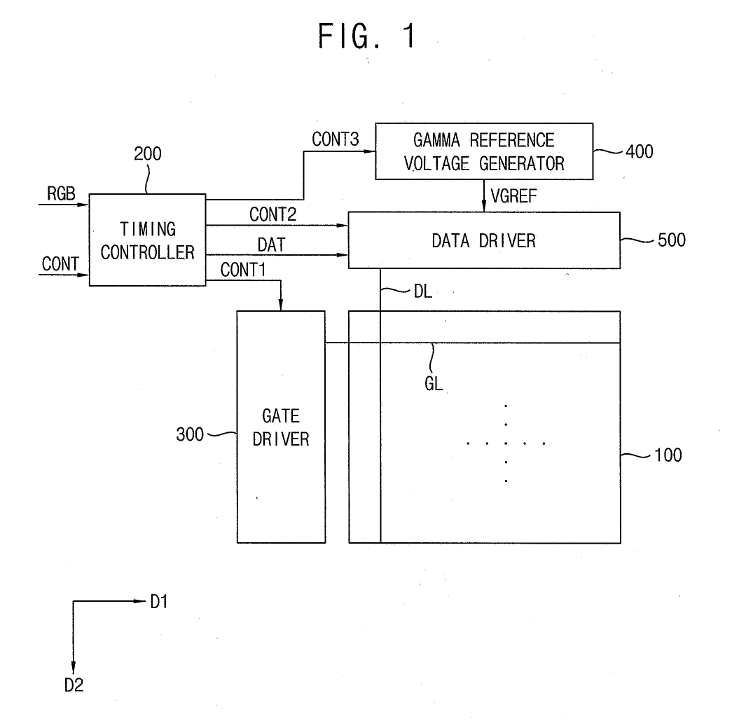

FIG. 1 is a block diagram illustrating a display apparatus according to an exemplary embodiment of the invention.

Referring to FIG. 1, an exemplary embodiment of the display apparatus includes a display panel 100 and a display panel driver. The display panel driver includes a timing controller 200, a gate driver 300, a gamma reference voltage generator 400 and a data driver 500.

The display panel 100 has a display region, on which an image is displayed, and a peripheral region adjacent to the display region.

The display panel 100 includes a plurality of gate lines GL, a plurality of data lines DL and a plurality of pixels electrically connected to the gate lines GL and the data lines DL. The gate lines GL extend in a first direction D1 and the data lines DL extend in a second direction D2 crossing the first direction D1.

Each pixel may include a switching element (not shown), a liquid crystal capacitor (not shown) and a storage capacitor (not shown). The liquid crystal capacitor and the storage capacitor are electrically connected to the switching element. The pixels may be disposed in a matrix form.

The timing controller 200 receives input image data RGB and an input control signal CONT from an external apparatus (not shown). Herein, the terms, the input image data RGB and input image signal, are used in substantially the same meaning as each other. The input image data RGB may include red image data, green image data and blue image data. The input control signal CONT may include a master clock signal and a data enable signal. The input control signal CONT may further include a vertical synchronizing signal and a horizontal synchronizing signal.

The timing controller 200 generates a first control signal CONT1, a second control signal CONT2, a third control signal CONT3 and a data signal DAT based on the input image data RGB and the input control signal CONT.

The timing controller 200 generates the first control signal CONT1 for controlling an operation of the gate driver 300 based on the input control signal CONT, and outputs the first control signal CONT1 to the gate driver 300. The first control signal CONT1 may further include a vertical start signal and a gate clock signal.

The timing controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The timing controller 200 generates the data signal DAT based on the input image data RGB. The timing controller 200 outputs the data signal DAT to the data driver 500. The data signal DAT may be substantially the same as the input image data RGB. Alternatively, the data signal DAT may be compensated image data generated by compensating the input image data RGB. In one exemplary embodiment, for example, the timing controller 200 may generate the data signal DAT by selectively operating at least one of a display quality compensation, a stain compensation, an adaptive color correction (“ACC”) and a dynamic capacitance compensation (“DCC”).

The timing controller 200 generates the third control signal CONT3 for controlling an operation of the gamma reference voltage generator 400 based on the input control signal CONT, and outputs the third control signal CONT3 to the gamma reference voltage generator 400.

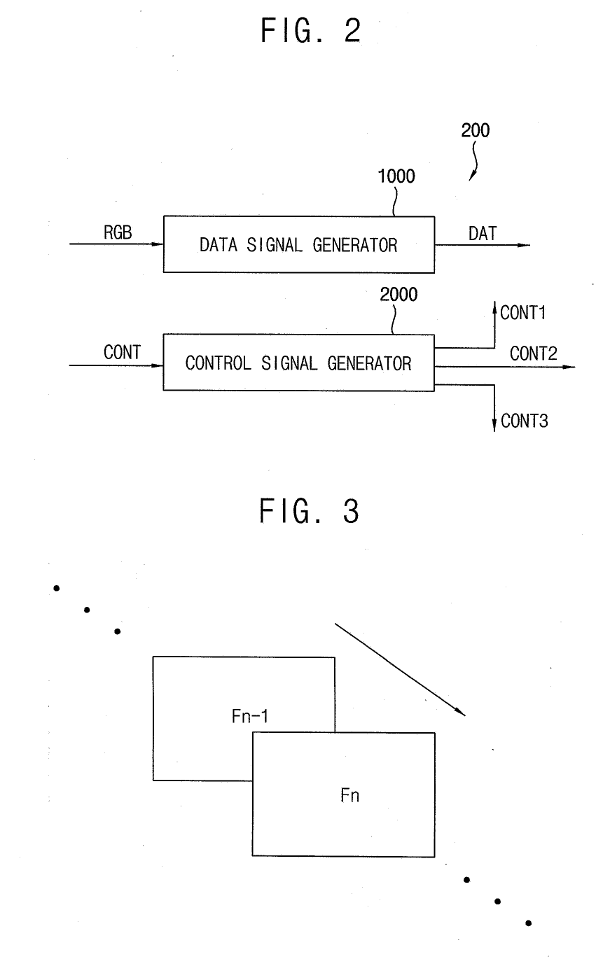

The structure and the operation of the timing controller 200 will be described later in greater detail referring to FIG. 2.

The gate driver 300 generates gate signals driving the gate lines GL in response to the first control signal CONT1 received from the timing controller 200. The gate driver 300 may sequentially output the gate signals to the gate lines GL.

The gate driver 300 may be disposed, e.g., directly mounted, on the display panel 100, or may be connected to the display panel 100 as a tape carrier package (“TCP”) type. Alternatively, the gate driver 300 may be integrated on the display panel 100.

The gamma reference voltage generator 400 generates a gamma reference voltage VGREF in response to the third control signal CONT3 received from the timing controller 200. The gamma reference voltage generator 400 provides the gamma reference voltage VGREF to the data driver 500. The gamma reference voltage VGREF has a value corresponding to a level of the data signal DAT.

In an alternative exemplary embodiment, the gamma reference voltage generator 400 may be disposed in the timing controller 200, or in the data driver 500.

The data driver 500 receives the second control signal CONT2 and the data signal DAT from the timing controller 200, and receives the gamma reference voltages VGREF from the gamma reference voltage generator 400. The data driver 500 converts the data signal DAT into data voltages having an analog type using the gamma reference voltages VGREF. The data driver 500 outputs the data voltages to the data lines DL.

The data driver 500 may be disposed, e.g., directly mounted, on the display panel 100, or be connected to the display panel 100 in a TCP type. Alternatively, the data driver 500 may be integrated on the display panel 100.

FIG. 2 is a block diagram illustrating an exemplary embodiment of the timing controller 200 of FIG. 1.

Referring to FIGS. 1 and 2, the timing controller 200 includes a data signal generator 1000 and a control signal generator 2000.

The data signal generator 1000 generates the data signal DAT based on the input image data RGB. The data signal generator 1000 outputs the data signal DAT to the data driver 500. The data signal generator 1000 may compensate the input image data RGB to generate the data signal DAT. In one exemplary embodiment, for example, the data signal generator 1000 may generate the data signal DAT by selectively operating at least one of the display quality compensation, the stain compensation, the ACC and the DCC.

The DCC is a method of compensating a grayscale value of the present frame image data based on based on previous frame image data and the present frame image data. The data signal generator 1000 may compensate the present frame image data based on the previous frame image data and the present frame image data to generate the data signal DAT. In an exemplary embodiment, where the data signal generator 1000 generates the data signal DAT by operating the DCC, the data signal generator 1000 may store the previous frame image data.

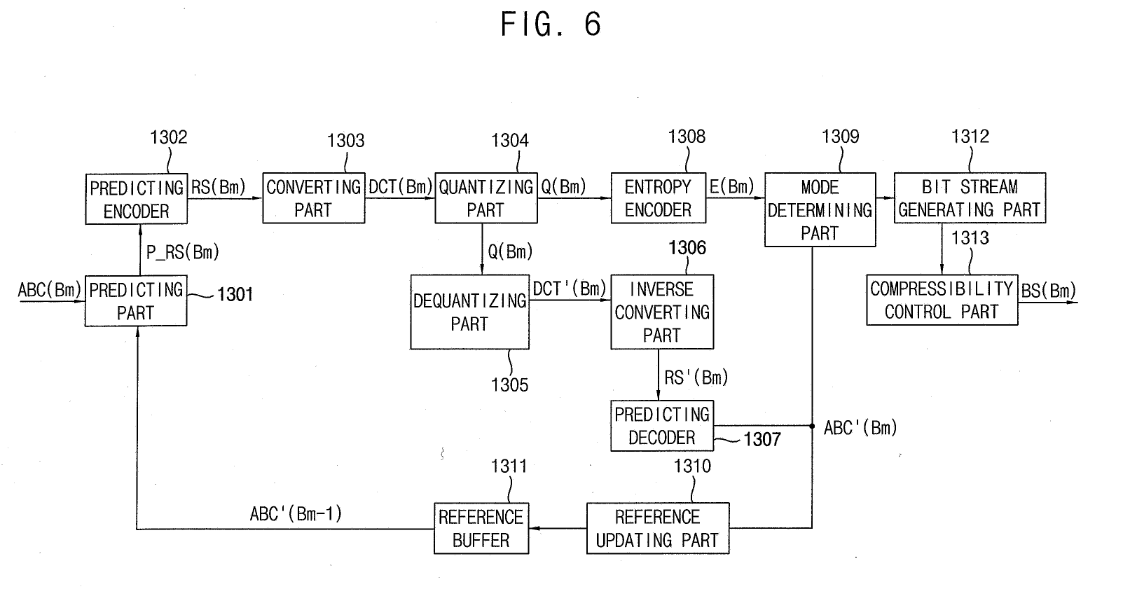

The structure and the operation of the data signal generator 1000 will be described later in greater detail referring to FIG. 5.

The control signal generator 2000 generates the first control signal CONT1, the second control signal CONT2 and the third control signal CONT3 based on the input control signal CONT. The control signal generator 2000 outputs the first control signal CONT1 to the gate driver 300. The control signal generator 2000 outputs the second control signal CONT2 to the data driver 500. The control signal generator 2000 outputs the third control signal CONT3 to the gamma reference voltage generator 400.

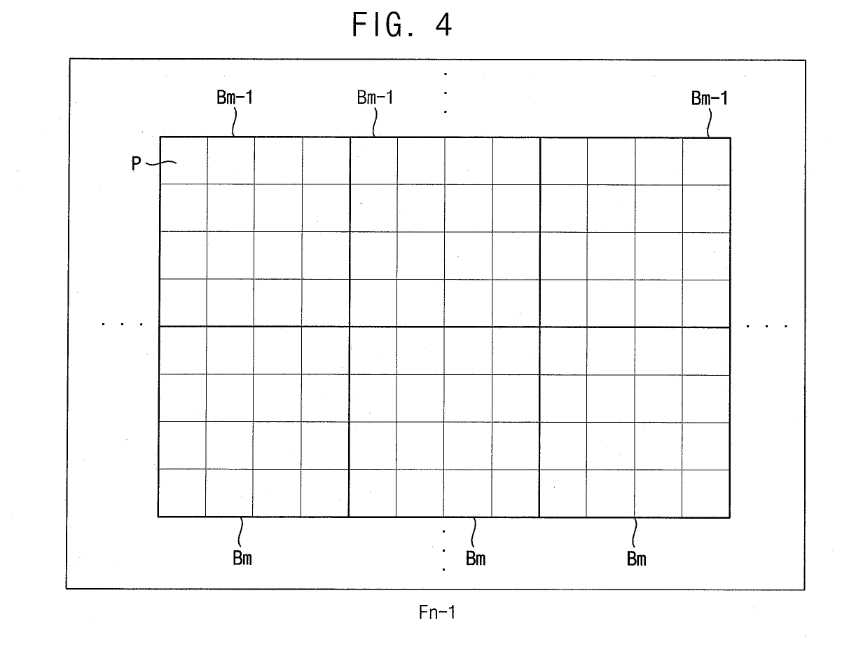

FIG. 3 is a conceptual diagram illustrating frames of an image displayed on the display panel 100 of FIG. 1.

Referring to FIGS. 1 to 3, the display panel 100 displays images per frames. In one exemplary embodiment, for example, the display panel 100 may display an image of an (n−1)-th frame Fn−1 and an image of an n-th frame Fn. In an exemplary embodiment, the n-th frame Fn may be a present frame and the (n−1)-th frame Fn−1 may be a previous frame.

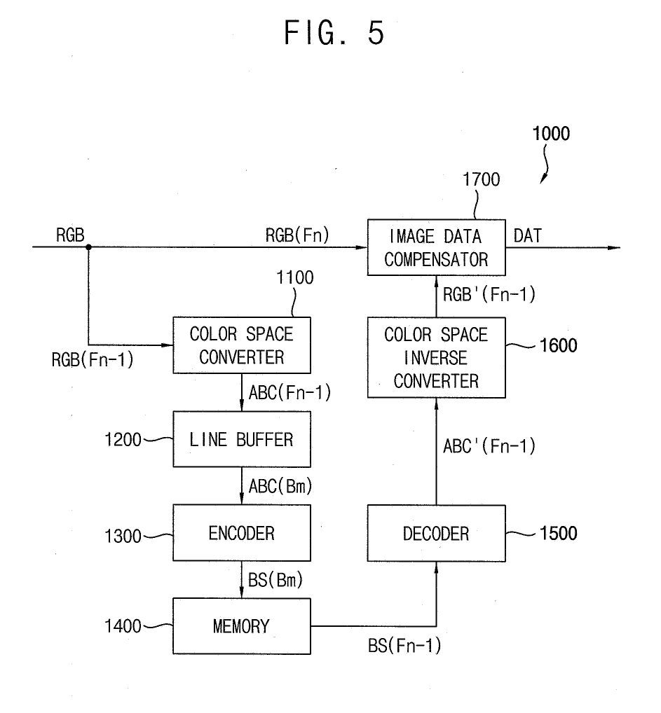

FIG. 4 is a conceptual diagram illustrating a structure of pixels and blocks in a frame of the frames of FIG. 3. FIG. 4 may represent a portion of the structure of the pixels and the blocks in the previous frame Fn−1.

Referring to FIGS. 1, 3 and 4, each block may be defined by 4×4 pixels P in each frame. In such an embodiment, the pixels may be divided into a plurality of block in a way such that each block is defined by 4×4 pixels P. In an exemplary embodiment, where the pixels are arranged substantially in a matrix form, the blocks may be arranged in a matrix form. The blocks in a same row may define a horizontal line or a horizontal block line. Herein, the block may also be referred to as a pixel block. In one exemplary embodiment, for example, each block may include 4×4 pixels P in the previous frame Fn−1. Each block may include sixteen pixels P in four rows and four columns. In one exemplary embodiment, for example, each of (m−1)-th blocks Bm−1 may include 4×4 pixels P and each of m-th blocks Bm may include 4×4 pixels P. The (m−1)-th blocks Bm−1 may be disposed in an (m−1)-th line in the display panel 100. The m-th blocks Bm may be disposed in an m-th line in the display panel 100. In an exemplary embodiment, each of the m-th blocks Bm may be a present block and each of the (m−1)-th blocks Bm−1 may be a previous block.

FIG. 5 is a block diagram illustrating an exemplary embodiment of the data signal generator 1000 of the timing controller 200 of FIG. 2.

Referring to FIGS. 1 to 5, an exemplary embodiment of the data signal generator 1000 includes a color space converter 1100, a line buffer 1200, an encoder 1300, a memory 1400, a decoder 1500, a color space inverse converter 1600 and an image data compensator 1700.

The color space converter 1100 receives frame input image data RGB(F) of each frame. The frame input image data RGB(F) may be image data in an RGB color space including red, green and blue. In one exemplary embodiment, for example, the color space converter 1100 receives previous frame input image data RGB(Fn−1) of the previous frame Fn−1. The previous frame input image data RGB(Fn−1) may be image data in the RGB color space.

The color space converter 1100 may convert the color space of the frame input image data RGB(F). In one exemplary embodiment, for example, the color space converter 1100 may convert the color space of the previous frame input image data RGB(Fn−1).

In one exemplary embodiment, for example, the color space converter 1100 may convert the color space of the previous frame input image data RGB(Fn−1) to YUV color space. The YUV color space includes a luminance component (Y) and chrominance components (U) and (V). The chrominance component U means a difference between the luminance component Y and a blue component B. The chrominance component V means a difference between the luminance component Y and a red component R. The YUV color space is used to increase the compressibility of the image.

Alternatively, the color space converter 1100 may convert the color space of the previous frame input image data RGB(Fn−1) to YCbCr color space. The YCbCr color space includes a luminance component Y and chrominance components Cb and Cr. The YCbCr color space is used to encode information of the RGB color space.

The color space converter 1100 outputs the converted frame image data ABC(F) of each frame to the line buffer 1200. In one exemplary embodiment, for example, the color space converter 1100 may output the converted previous frame image data ABC(Fn−1) to the line buffer 1200.

The line buffer 1200 delays the converted frame image data ABC(F) by a block line, and outputs block image data of each block to the encoder 1300. In one exemplary embodiment, for example, the line buffer 1200 delays the converted previous frame image data ABC(Fn−1) by a block line, and outputs block image data ABC(B) of each block to the encoder 1300. In one exemplary embodiment, for example, the line buffer 1200 outputs present block image data ABC(Bm) of a present block line to the encoder 1300. The line buffer 1200 operates the above-described operation for all of the block lines of the frame. In one exemplary embodiment, for example, the line buffer 1200 operates the above-described operation for all of the block lines of the previous frame Fn−1.

The encoder 1300 encodes and compresses the block image data ABC(B) and outputs the block encoded data BS(B) of each block to the memory 1400. In one exemplary embodiment, for example, the encoder 1300 encodes and compresses the present block image data ABC(Bm), and outputs the present block encoded data BS(Bm) to the memory 1400. The present block encoded data BS(Bm) may be a bit stream.

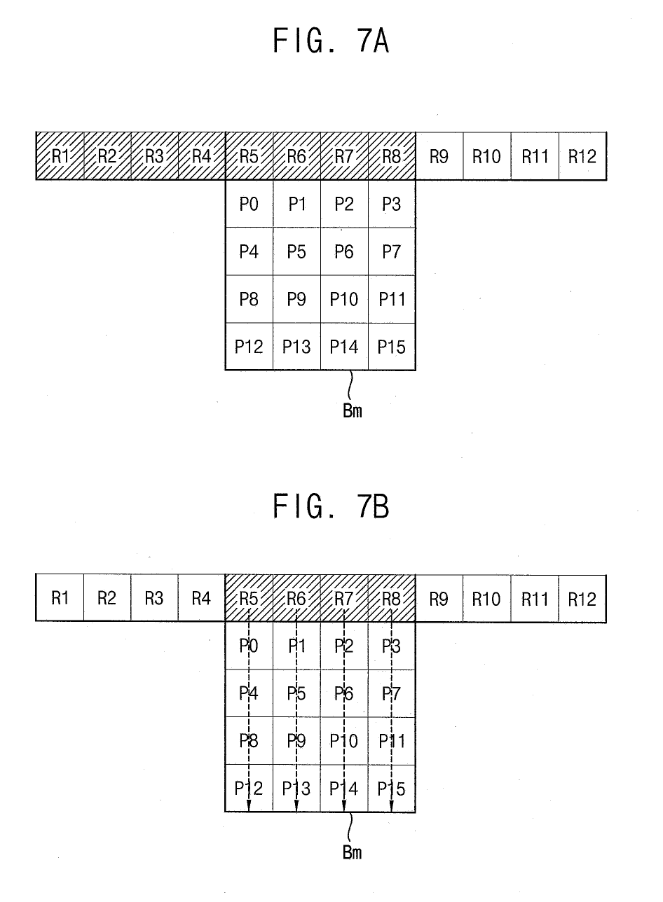

The operation of the encoder 1300 will be described later in greater detail referring to FIG. 6.

The memory 1400 stores the block encoded data BS(B). In one exemplary embodiment, for example, the memory 1400 stores the present block encoded data BS(Bm). The memory 1400 operates the above-described operation for all of the block lines of the frame. In one exemplary embodiment, for example, the memory 1400 operates the above-described operation for all of the block lines of the previous frame Fn−1. The memory 1400 stores the block encoded data BS(B) of all of the block lines of the previous frame Fn−1.

The memory 1400 provides the frame encoded data BS(F) to the decoder 1500 based on the block encoded data of all of the block lines of each frame. In one exemplary embodiment, for example, the memory 1400 provides the previous frame encoded data BS(Fn−1) of the previous frame Fn−1 to the decoder 1500 based on the block encoded data BS(B) of all of the block lines of the previous frame Fn−1.

The decoder 1500 decodes the frame encoded data BS(F) to generate frame decoded data ABC′(F). In one exemplary embodiment, for example, the decoder 1500 decodes the previous frame encoded data BS(Fn−1) of the previous frame Fn−1 to generate previous frame decoded data ABC′(Fn−1). The decoder 1500 outputs the previous frame decoded data ABC′(Fn−1) to the color space inverse converter 1600.

The color space inverse converter 1600 inversely convert the color space of the frame decoded data ABC′(F). The color space inverse converter 1600 may operate the inverse conversion of the converted color space by the color space converter 1100. In one exemplary embodiment, for example, the color space inverse converter 1600 may convert the color space of the frame decoded data ABC′(F) which is the YUV color space or the YCbCr color space to the RGB color space. The color space inverse converter 1600 may inversely convert the color space of the frame decoded data ABC′(F) to generate frame restored image data RGB′(F). In one exemplary embodiment, for example, the color space inverse converter 1600 may inversely convert the color space of the previous frame decoded data ABC′(Fn−1) to generate previous frame restored image data RGB′(Fn−1). The previous frame restored image data RGB′(Fn−1) may have the RGB color space. The color space inverse converter 1600 outputs the previous frame restored image data RGB′(Fn−1) to the image data compensator 1700.

The image data compensator 1700 receives present frame input image data RGB(Fn) and the previous frame restored image data RGB′(Fn−1). The image data compensator 1700 compensates the present frame input image data RGB(Fn) based on the present frame input image data RGB(Fn) and the previous frame restored image data RGB′(Fn−1), and thereby generates the data signal DAT corresponding to the present frame Fn. The image data compensator 1700 operates the above-described operation for all of the frames. The above-described compensation may be the DCC. The image data compensator 1700 outputs the data signal DAT to the data driver 500.

FIG. 6 is a block diagram illustrating an exemplary embodiment of the encoder 1300 of the data signal generator 1000 of FIG. 5.

Referring to FIGS. 1 to 6, an exemplary embodiment of the encoder 1300 includes a predicting part 1301, a predicting encoder 1302, a converting part 1303, a quantizing part 1304, a dequantizing part 1305, an inverse converting part 1306, a predicting decoder 1307, an entropy encoder 1308, a mode determining part 1309, a reference updating part 1310, a reference buffer 1311, a bit stream generating part 1312 and a compressibility control part 1313.

The predicting part 1301 receives the previous block decoded image data ABC′(Bm−1) of the previous block Bm−1 from the reference buffer 1311. The predicting part 1301 receives the present block image data ABC(Bm) from the line buffer 1200. The predicting part 1301 generate a present block predicted residual signal P_RS(Bm) based on the previous block decoded image data ABC′(Bm−1) and the present block image data ABC(Bm). The present block predicted residual signal P_RS(Bm) may be difference between the present block image data ABC(Bm) and the previous block decoded image data ABC′(Bm−1). The present block predicted residual signal P_RS(Bm) may be plural.

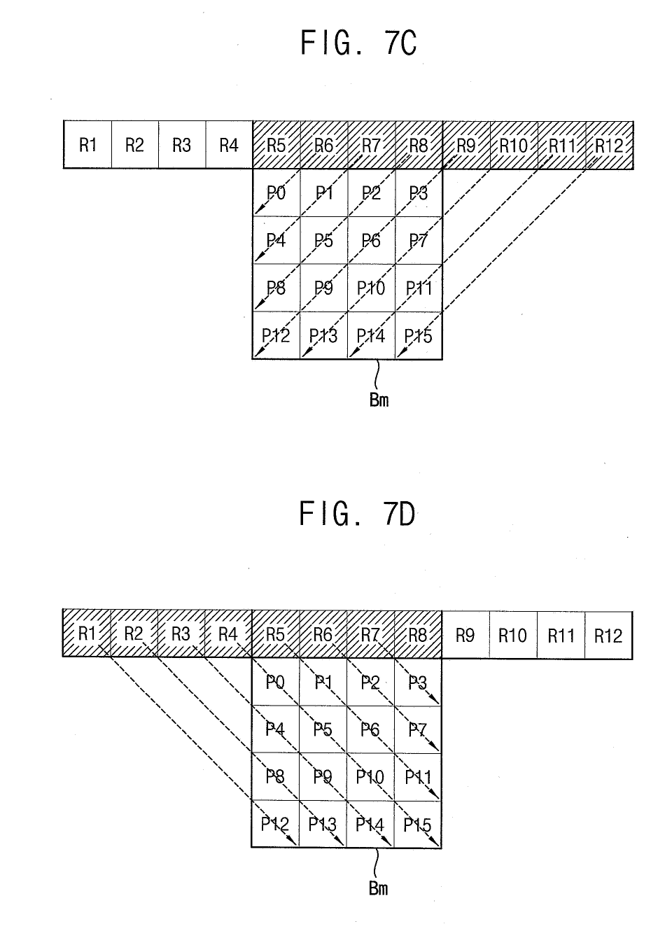

The method of generating the present block predicted residual signal P_RS(Bm) based on the previous block decoded image data ABC′(Bm−1) and the present block image data ABC(Bm) by the predicting part 1301 will be described later in greater detail referring to FIGS. 7A to 7D.

The predicting encoder 1302 encodes the present block predicted residual signal P_RS(Bm) to generate a present block residual signal RS(Bm). The present block residual signal RS(Bm) may be plural. The predicting encoder 1302 outputs the present block residual signal RS(Bm) to the converting part 1303.

The converting part 1303 applies discrete cosine transform (“DCT”) to the present block residual signal RS(Bm) to generate a present block DCT signal DCT(Bm). The present block DCT signal DCT(Bm) may be plural. In an exemplary embodiment, the present block residual signal RS(Bm) in a time domain may be transformed to the present block DCT signal DCT(Bm) in a frequency domain by the DCT. In such an embodiment, the present block residual signal RS(Bm) having 4×4 residual signal data for a block may be transformed to the present block DCT signal DCT(Bm) having 4×4 DCT coefficients for the block by the DCT. In an exemplary embodiment, the converting part 1303 may selectively skip the DCT operation according to the input image. In one exemplary embodiment, for example, the converting part 1303 may skip the DCT operation when the input image having preset specific patterns. The converting part 1303 outputs the present block DCT signal DCT(Bm) to the quantizing part 1304.

The quantizing part 1304 quantizes the present block DCT signal DCT(Bm) to generate a present block quantized signal Q(Bm). In the quantization process, the DCT coefficient is divided by a quantizing coefficient and then be rounded off. The quantizing coefficient may have a value between zero and 51. The present block quantized signal Q(Bm) may be plural. The quantizing part 1304 outputs the present block quantized signal Q(Bm) to the entropy encoder 1308 and the dequantizing part 1305.

The dequantizing part 1305 dequantizes the present block quantized signal Q(Bm) to generate a present block deuantized signal DCT′(Bm). The dequantization process may be an inverted process of the quantization process. The present block dequantized signal DCT′(Bm) may be plural. The dequantizing part 1305 outputs the present block dequantized signal DCT′(Bm) to the inverse converting part 1306.

The inverse converting part 1306 inversely convert the present block dequantized signal DCT′(Bm) to generate a present block inverse converted signal RS′(Bm). The inversely converting process may be an inverted process of the DCT. In an exemplary embodiment, the present block dequantized signal DCT′(Bm) in the frequency domain may be converted to the present block inverse converted signal RS′(Bm) in the time domain by the inversely converting process. The present block inverse converted signal RS′(Bm) may be plural. In an exemplary embodiment, the inverse converting part 1306 may selectively skip the inversely converting operation according to the input image. In one exemplary embodiment, for example, when the converting part 1303 skips the DCT operation, the inverse converting part 1306 may skip the inversely converting operation. The inverse converting part 1306 outputs the present block inverse converted signal RS′(Bm) to the predicting decoder 1307.

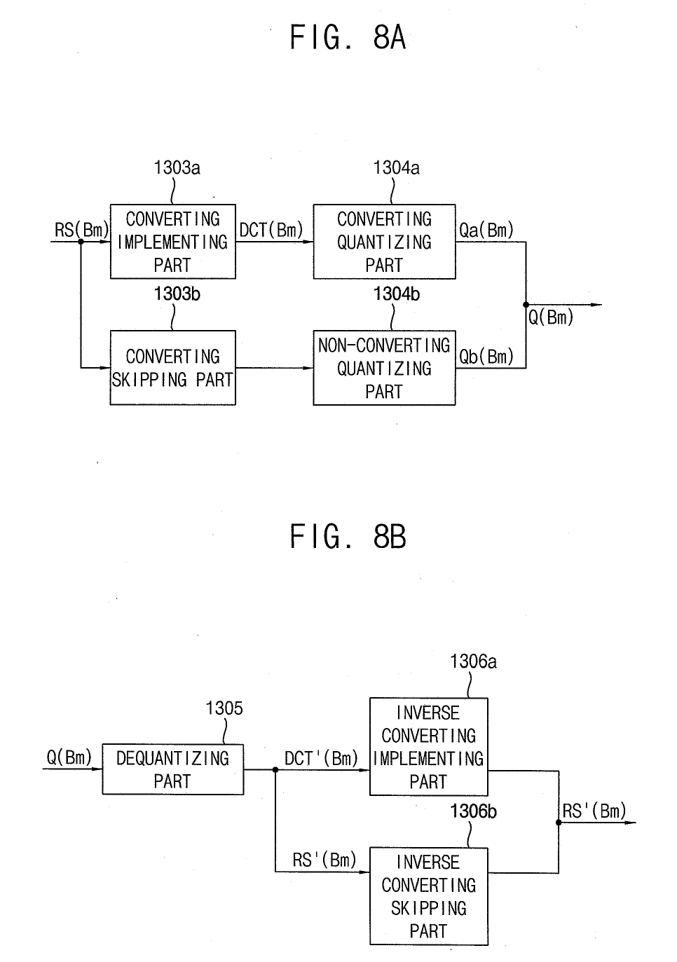

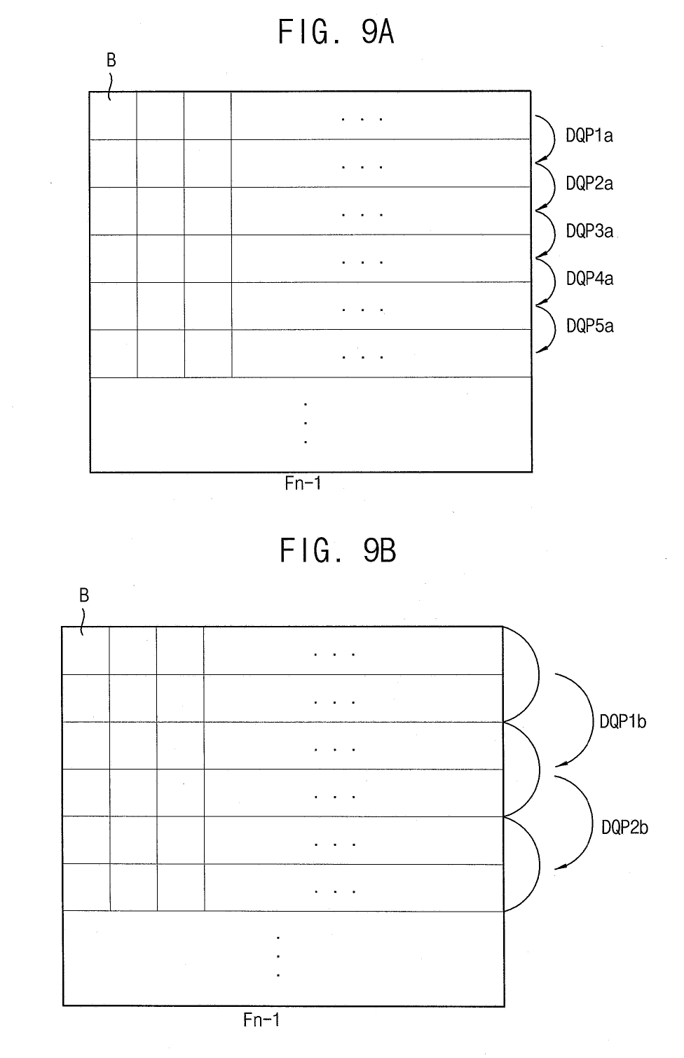

The operations of the converting part 1303, the quantizing part 1304, the dequantizing part 1305 and the inverse converting part 1306 according to whether the DCT operation is skipped or not will be described later in greater detail referring to FIGS. 8A and 8B.

The predicting decoder 1307 decodes the present block inverse converted signal RS′(Bm) to generate the present block decoded image data ABC′(Bm). The decoding process of the predicting decoder 1307 may be an inverted process of the encoding process of the predicting encoder 1302. The present block decoded image data ABC′(Bm) may be plural. The predicting decoder 1307 outputs the present block decoded image data ABC′(Bm) to the mode determining part 1309 and the reference updating part 1310.

The entropy encoder 1308 entropy-encodes the present block decoded image data ABC′(Bm) to generate a present block entropy encoded signal E(Bm). The present block entropy encoded signal E(Bm) may be plural. The entropy encoder 1308 outputs the present block entropy encoded signal E(Bm) to the mode determining part 1309.

The mode determining part 1309 selects one of the present block entropy encoded signals E(Bm) based on the present block decoded image data ABC′(Bm), and outputs the selected present block entropy encoded signal E(Bm) to the bit stream generating part 1312. The mode determining part 1309 may select the present block entropy encoded signal E(Bm) corresponding to a present block decoded image data ABC′(Bm) that is closest to the present block image data ABC(Bm) among the present block decoded image data ABC′(Bm).

The reference updating part 1310 receives the present block decoded image data ABC′(Bm), and updates the previous block decoded image data, which is stored in the reference buffer 1311. The reference buffer 1311 outputs the present block decoded image data ABC′(Bm) to the predicting part 1301 as the previous block decoded image data ABC′(Bm−1). When the predicting part 1301 receives the present block image data ABC(Bm) from the line buffer 1200, the reference buffer 1311 provides the previous block decoded image data ABC′(Bm−1) to the predicting part 1301.

The bit stream generating part 1312 generates a bit stream of the present block entropy encoded signal E(Bm) selected by the mode determining part 1309, and outputs the bit stream to the compressibility control part 1313.

The compressibility control part 1313 determines compressibility of a next block based on the present block entropy encoded signal E(Bm). The compressibility control part 1313 may provide the compressibility information with the bit stream to the memory 1400 as the present block encoded data BS(Bm).

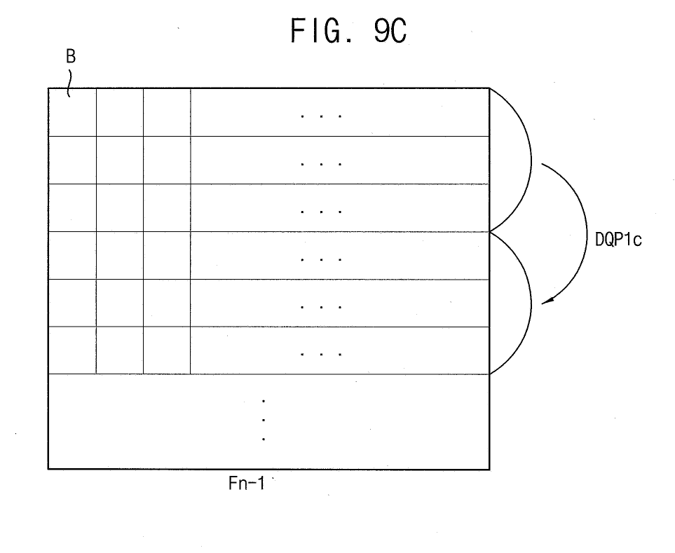

An exemplary embodiment of a method of determining the compressibility of the next block by the compressibility control part 1313 will be described later in greater detail referring to FIGS. 9A and 9B.

FIGS. 7A to 7D are conceptual diagrams illustrating an exemplary embodiment of a method of predicting image data operated by the predicting part 1301 of the encoder 1300 of FIG. 6.

Referring to FIGS. 1 to 6 and 7A to 7D, in an exemplary embodiment, the present block Bm includes 4×4 pixels P0 to P15. In such an embodiment, reference pixels R1 to R12 are disposed in a last line of the previous block Bm−1.

The predicting part 1301 predicts the image data of the pixels P0 to P15 of the present block Bm based on the first to twelfth reference pixels R1 to R12. The predicting part 1301 predicts the image data of the pixels P0 to P15 of the present block Bm based on image data of the first to twelfth reference pixels R1 to R12 included in the previous block decoded image data ABC′(Bm−1). Exemplary embodiments of a method of predicting will hereinafter be described referring to FIGS. 7A to 7D. However, the invention is not limited thereto.

Referring to FIG. 7A, in an exemplary embodiment, the predicting part 1301 may predict the image data of the pixels P0 to P15 of the present block Bm based on average of the previous block decoded image data ABC′(Bm−1) of some of the first to twelfth reference pixels R1 to R12. In one exemplary embodiment, for example, the predicting part 1301 may predict the image data of the pixels P0 to P15 of the present block Bm based on average of the previous block decoded image data ABC′(Bm−1) of the first to eighth reference pixels R1 to R8. In one exemplary embodiment, for example, the predicting part 1301 may calculate differences of each of the present block image data ABC(Bm) of the pixels P0 to P15 of the present block Bm and the average to generate the present block predicted residual signal P_RS(Bm).

Referring to FIG. 7B, in an alternative exemplary embodiment, the predicting part 1301 may predict the image data of the pixels P0 to P15 of the present block Bm based on the previous block decoded image data ABC′(Bm−1) of the reference pixels adjacent to the present block Bm among the first to twelfth reference pixels R1 to R12. In one exemplary embodiment, for example, the predicting part 1301 may predict the image data of the pixels P0 to P15 of the present block Bm based on the previous block decoded image data ABC′(Bm−1) of the fifth to eighth reference pixels R5 to R8 in a lower direction in FIG. 7B. In such an embodiment, the predicting part 1301 may calculate differences between each of the present block image data ABC(Bm) of the pixels P0, P4, P8 and P12 in a first column among the pixels P0 to P15 of the present block Bm and the previous block decoded image data ABC′(Bm−1) of the fifth reference pixel R5, differences between each of the present block image data ABC(Bm) of the pixels P1, P5, P9 and P13 in a second column among the pixels P0 to P15 of the present block Bm and the previous block decoded image data ABC′(Bm−1) of the sixth reference pixel R6, differences between each of the present block image data ABC(Bm) of the pixels P2, P6, P10 and P14 in a third column among the pixels P0 to P15 of the present block Bm and the previous block decoded image data ABC′(Bm−1) of the seventh reference pixel R7 and differences between each of the present block image data ABC(Bm) of the pixels P 3, P7, P11 and P15 in a fourth column among the pixels P0 to P15 of the present block Bm ad the previous block decoded image data ABC′(Bm−1) of the eighth reference pixel R8 to generate the present block predicted residual signal P_RS(Bm).

Referring to FIG. 7C, in another alternative exemplary embodiment, the predicting part 1301 may predict the image data of the pixels P0 to P15 of the present block Bm based on the previous block decoded image data ABC′(Bm−1) of the reference pixels adjacent to the present block Bm and the reference pixels disposed a right side in FIG. 7C among the first to twelfth reference pixels R1 to R12. In one exemplary embodiment, for example, the predicting part 1301 may predict the image data of the pixels P0 to P15 of the present block Bm based on the previous block decoded image data ABC′(Bm−1) of the fifth to twelfth reference pixels R5 to R12 in a diagonal direction toward left and lower direction in FIG. 7C. In such an embodiment, the predicting part 1301 may calculate differences between the present block image data ABC(Bm) of the pixel P0 in a first diagonal line among the pixels P0 to P15 of the present block Bm and the previous block decoded image data ABC′(Bm−1) of the sixth reference pixel R6, differences between each of the present block image data ABC(Bm) of the pixels P1 and P4 in a second diagonal line among the pixels P0 to P15 of the present block Bm and the previous block decoded image data ABC′(Bm−1) of the seventh reference pixel R7, differences between each of the present block image data ABC(Bm) of the pixels P2, P5 and P8 in a third diagonal line among the pixels P0 to P15 of the present block Bm and the previous block decoded image data ABC′(Bm−1) of the eighth reference pixel R8, differences between each of the present block image data ABC(Bm) of the pixels P3, P6, P9 and P12 in a fourth diagonal line among the pixels P0 to P15 of the present block Bm and the previous block decoded image data ABC′(Bm−1) of the ninth reference pixel R9, differences between each of the present block image data ABC(Bm) of the pixels P7, P10 and P13 in a fifth diagonal line among the pixels P0 to P15 of the present block Bm and the previous block decoded image data ABC′(Bm−1) of the tenth reference pixel R10, differences between each of the present block image data ABC(Bm) of the pixels P11 and P14 in a sixth diagonal line among the pixels P0 to P15 of the present block Bm and the previous block decoded image data ABC′(Bm−1) of the eleventh reference pixel R11 and differences between the present block image data ABC(Bm) of the pixel P15 in a seventh diagonal line among the pixels P0 to P15 of the present block Bm and the previous block decoded image data ABC′(Bm−1) of the twelfth reference pixel R12 to generate the present block predicted residual signal P_RS(Bm).

Referring to FIG. 7D, in another alternative exemplary embodiment, the predicting part 1301 may predict the image data of the pixels P0 to P15 of the present block Bm based on the previous block decoded image data ABC′(Bm−1) of the reference pixels adjacent to the present block Bm and the reference pixels disposed a left side in FIG. 7D among the first to twelfth reference pixels R1 to R12. In one exemplary embodiment, for example, the predicting part 1301 may predict the image data of the pixels P0 to P15 of the present block

Bm based on the previous block decoded image data ABC′(Bm−1) of the first to eighth reference pixels R1 to R8 in a diagonal direction toward right and lower direction in FIG. 7D. In such an embodiment, the predicting part 1301 may calculate differences between the present block image data ABC(Bm) of the pixel P12 in a first diagonal line among the pixels P0 to P15 of the present block Bm and the previous block decoded image data ABC′(Bm−1) of the first reference pixel R1, differences between each of the present block image data ABC(Bm) of the pixels P8 and P13 in a second diagonal line among the pixels P0 to P15 of the present block Bm and the previous block decoded image data ABC′(Bm−1) of the second reference pixel R2, differences between each of the present block image data ABC(Bm) of the pixels P4, P9 and P14 in a third diagonal line among the pixels P0 to P15 of the present block Bm and the previous block decoded image data ABC′(Bm−1) of the third reference pixel R3, differences between each of the present block image data ABC(Bm) of the pixels P0, P5, P10 and P15 in a fourth diagonal line among the pixels P0 to P15 of the present block Bm and the previous block decoded image data ABC′(Bm−1) of the fourth reference pixel R4, differences between each of the present block image data ABC(Bm) of the pixels P1, P6 and P11 in a fifth diagonal line among the pixels P0 to P15 of the present block Bm and the previous block decoded image data ABC′(Bm−1) of the fifth reference pixel R5, differences between each of the present block image data ABC(Bm) of the pixels P2 and P7 in a sixth diagonal line among the pixels P0 to P15 of the present block Bm and the previous block decoded image data ABC′(Bm−1) of the sixth reference pixel R6 and differences between the present block image data ABC(Bm) of the pixel P3 in a seventh diagonal line among the pixels P0 to P15 of the present block Bm and the previous block decoded image data ABC′(Bm−1) of the seventh reference pixel R7 to generate the present block predicted residual signal P_RS(Bm).

According to an exemplary embodiment, as shown in FIGS. 7A to 7D, the present block image data may be predicted only using the already encoded, compressed and decoded previous block image data.

FIG. 8A is a block diagram illustrating an exemplary embodiment of the converting part 1303 and the quantizing part 1304 of the encoder 1300 of FIG. 6. FIG. 8B is a block diagram illustrating an exemplary embodiment of the inverse converting part 1306 and the dequantizing part 1305 of the encoder 1300 of FIG. 6.

Referring to FIGS. 1 to 6 and 8A to 8B, the converting part 1303 may implement or skip the DCT according to the input image. In one exemplary embodiment, for example, the converting part 1303 may skip the DCT when the input image includes a specific pattern. The converting part 1303 may implement the DCT when the input image does not include the specific pattern. The specific pattern may be a pattern predetermined as being improper for the compress when the DCT is implemented.

The converting part 1303 may include a converting implementing part 1303a and a converting skipping part 1303b. The quantizing part 1304 may include a converting quantizing part 1304a and a non-converting quantizing part 1304b.

When the converting part 1303 implements the DCT, the converting implementing part 1303a implements the DCT based on the present block residual signal RS(Bm) to generate the present block DCT signal DCT(Bm). The converting quantizing part 1304a quantizes the present block DCT signal DCT(Bm) to generate the present block quantized signal Qa(Bm). The quantization may be implemented in the frequency domain

When the converting part 1303 skips the DCT, the converting skipping part 1303b merely transmits the present block residual signal RS(Bm) to the non-converting quantizing part 1304b. The non-converting quantizing part 1304b quantizes the present block residual signal RS(Bm) to generate the present block quantized signal Qb(Bm). The quantization may be implemented in the time domain.

The inverse converting part 1306 may include an inverse converting implementing part 1306a and an inverse converting skipping part 1306b.

The dequantizing part 1305 dequantizes the present block quantized signal Q(Bm). In one exemplary embodiment, for example, the dequantizing part 1305 dequantizes the present block quantized signal Qa(Bm) in the frequency domain to generate the present block dequantized signal DCT′(Bm) in the frequency domain and outputs the present block dequantized signal DCT′(Bm) to the inverse converting implementing part 1306a. In an alternative exemplary embodiment, the dequantizing part 1305 dequantizes the present block quantized signal Qb(Bm) in the time domain to generate the present block dequantized signal in the time domain and outputs the present block dequantized signal to the inverse converting skipping part 1306b. In such an embodiment, the present block dequantized signal in the time domain may be substantially the same as the present block inverse converted signal RS′(Bm).

The inverse converting implementing part 1306a inversely converts the present block dequantized signal DCT′(Bm) to generate the present block inverse converted signal RS′(Bm). In such an embodiment, as shown in FIG. 6, the inverse converting implementing part 1306a outputs the present block inverse converted signal RS′(Bm) to the predicting decoder 1307. The inverse converting skipping part 1306b merely transmits the present block inverse converted signal RS′(Bm) to the predicting decoder 1307.

According to an exemplary embodiment, as shown in FIGS. 8A and 8B, the DCT is skipped for the input image improper for the compress because of compressibility when the DCT is implemented. Thus, the compressibility of the image may be improved.

FIGS. 9A to 9C are conceptual diagrams illustrating an exemplary embodiment of a method of controlling a compressibility operated by the compressibility control part 1313 of the encoder 1300 of FIG. 6.

Referring to FIGS. 1 to 6 and 9A, the compressibility control part 1313 determines the compressibility of the next block based on the present block entropy encoded signal E(Bm) of the blocks in the present block line. In one exemplary embodiment, for example, the compressibility control part 1313 may compare a target compressibility and a practical compressibility until the present block line based on the present block entropy encoded signal E(Bm) to determine the compressibility of the next block line. The compressibility control part 1313 may generate a quantizing coefficient difference DQPa between a quantizing coefficient of the present block line and a quantizing coefficient of the next block line. The quantizing coefficient difference DQPa is used for achievement of the target compressibility. The compressibility of the next block line may be adjusted by the quantizing coefficient of the next block line. The compressibility control part 1313 outputs the quantizing coefficient difference DQPa to the memory 1400 with the bit stream as the present block encoded data BS(Bm).

In one exemplary embodiment, for example, the compressibility control part 1313 may determine a compressibility of a second block line by comparing the target compressibility to the practical compressibility of a first block line based on the block entropy encoded signal of the blocks of the first block line. The compressibility control part 1313 may generate a first quantizing coefficient difference DQP1a corresponding to the compressibility of the second block line. The first quantizing coefficient difference DQP1a is the difference between the quantizing coefficient of the first block line and the determined quantizing coefficient of the second block line.

The compressibility control part 1313 may determine a compressibility of a third block line by comparing the target compressibility to the practical compressibility until the second block line based on the block entropy encoded signal of the blocks of the second block line. The compressibility control part 1313 may generate a second quantizing coefficient difference DQP2a corresponding to the compressibility of the third block line. The second quantizing coefficient difference DQP2a is the difference between the quantizing coefficient of the second block line and the determined quantizing coefficient of the third block line. In such an embodiment, the compressibility control part 1313 may generate third to fifth quantizing coefficient differences DQP3a−DOP5a corresponding to the compressibility of the fourth to sixth block lines, respectively.

Referring to FIGS. 9B and 9C, a unit of the compressibility control may be set to a plurality of block lines.

In one exemplary embodiment, for example, referring to FIG. 9B, the compressibility control part 1313 may determine a compressibility of third and fourth block lines by comparing the target compressibility to the practical compressibility until the second block line based on the block entropy encoded signal of the blocks of the first and second block lines. The compressibility control part 1313 may generate a first quantizing coefficient difference DQP1b corresponding to the compressibility of the third and fourth block lines. The first quantizing coefficient difference DQP1b is the difference between the quantizing coefficient of the first and second block lines and the determined quantizing coefficient of the third and fourth block lines. The compressibility control part 1313 may generate a second quantizing coefficient difference DQP2b corresponding to the compressibility of the fifth and sixth block lines. The second quantizing coefficient difference DQP2b is the difference between the quantizing coefficient of the third and fourth block lines and the determined quantizing coefficient of the fifth and sixth block lines

In one exemplary embodiment, for example, referring to FIG. 9C, the compressibility control part 1313 may determine a compressibility of fourth to sixth block lines by comparing the target compressibility to the practical compressibility until the third block line based on the block entropy encoded signal of the blocks of the first to third block lines. The compressibility control part 1313 may generate a first quantizing coefficient difference DQP1c corresponding to the compressibility of the fourth to sixth block lines. The first quantizing coefficient difference DQP1c is the difference between the quantizing coefficient of the first to third block lines and the determined quantizing coefficient of the fourth to sixth block lines.

According to an exemplary embodiment, as shown in FIGS. 9A to 9C, the achievement of the target compressibility may be determined in specific units of the blocks to adjust the compressibility of the next block. In such an embodiment, the compressibility may be adjusted based only on the difference of the quantizing coefficient of the present block and the quantizing coefficient of the next block.

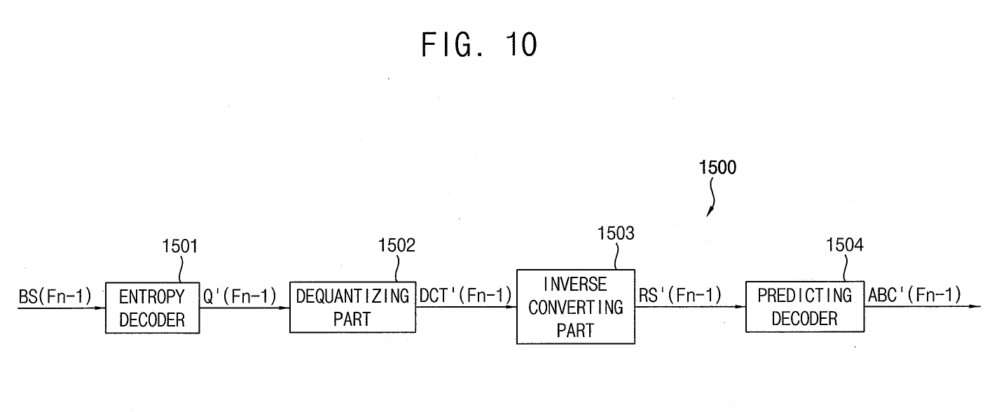

FIG. 10 is a block diagram illustrating an exemplary embodiment of the decoder 1500 of the data signal generator 1000 of FIG. 5.

Referring to FIGS. 1 to 6 and 10, an exemplary embodiment of the decoder 1500 includes an entropy decoder 1501, a dequantizing part 1502, an inverse converting part 1503 and a predicting decoder 1504.

The entropy decoder 1501 entropy-decodes the previous frame encoded data BS(Fn−1) to generate a previous frame entropy decoded signal Q′(Fn−1). The entropy decoding process may be an inverted process of the entropy encoding process operated by the entropy encoder 1308. The entropy decoder 1501 outputs the previous frame entropy decoded signal Q′(Fn−1) to the dequantizing part 1502.

The dequantizing part 1502 dequantizes the previous frame entropy decoded signal Q′(Fn−1) to generate a previous frame dequantized signal DCT′(Fn−1). The dequantizing part 1502 outputs the previous frame dequantized signal DCT′(Fn−1) to the inverse converting part 1503.

The inverse converting part 1503 inversely converts the previous frame dequantized signal DCT′(Fn−1) to generate a previous frame inverse converted signal RS′(Fn−1). The inverse converting part 1503 outputs the previous frame inverse converted signal RS′(Fn−1) to the predicting decoder 1504.

The predicting decoder 1504 decodes the previous frame inverse converted signal RS′(Fn−1) to generate the previous frame decoded data ABC′(Fn−1). The predicting decoder 1504 outputs the previous frame decoded data ABC′(Fn−1) to the color space inverse converter 1600.

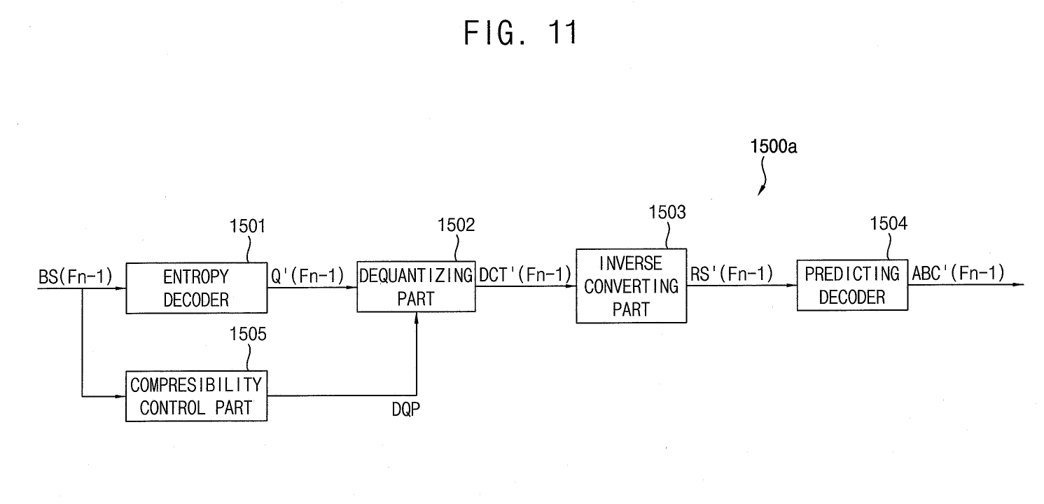

FIG. 11 is a block diagram illustrating an alternative exemplary embodiment of the decoder 1500a of the data signal generator 1000 of FIG. 5. The repetitive explanations explained referring to FIG. 10 are omitted.

Referring to FIGS. 1 to 6 and 11, an exemplary embodiment of the decoder 1500a includes an entropy decoder 1501, a dequantizing part 1502, an inverse converting part 1503 and a predicting decoder 1504. In such an embodiment, the decoder 1500a may further include a compressibility control part 1505.

In an exemplary embodiment, as shown in FIG. 6, the compressibility control part 1313 included in the encoder 1300 may determines the compressibility of the next block based on the present block entropy encoded signal E(Bm).

The operation of the compressibility control part 1505 shown in FIG. 11 may be substantially the same as the operation of the compressibility control part 1313 included in the encoder 1300 in FIG. 6. The compressibility control part 1505 determines the compressibility of the blocks based on the previous frame encoded data BS(Fn−1) and outputs the quantizing coefficient difference DQP to the dequantizing part 1502.

The dequantizing part 1502 determines the quantizing coefficient based on the quantizing coefficient difference DQP, and dequantizes the previous frame entropy decoded signal Q′(Fn−1) to generate a previous frame dequantized signal DCT′(Fn−1).

According to an exemplary embodiment, as shown in FIG. 11, the compressibility control part 1505 is further disposed in the decoder 1500a so that the encoder 1300 may not output the compressibility of the next block to the decoder 1500a.

Exemplary embodiments of the invention may be applied to a display apparatus and various apparatuses and system including the display apparatus. Thus, exemplary embodiments of the invention may be applied to various electric apparatuses such as cellular phone, a smart phone, a PDA, a PMP, a digital camera, a camcorder, a personal compute, a server computer, a workstation, a laptop, a digital TV, a set-top box, a music player, a portable game console, a navigation system, a smart card and a printer.

The foregoing is illustrative of the invention and is not to be construed as limiting thereof. Although a few exemplary embodiments of the invention have been described, those skilled in the art will readily appreciate that various modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of compressing image data in a display apparatus in a unit of block including a plurality of pixels, the method comprising:
generating a residual signal by predicting image data of a plurality of second blocks disposed in a second horizontal line using image data of a plurality of first blocks disposed in a first horizontal line, wherein the second horizontal line is disposed under the first horizontal line;
determining whether operating discrete cosine transform to the residual signal or not based on an input image;
compressing the image data of the second blocks; and
determining compressibility of image data of a plurality of third blocks disposed in a third horizontal line disposed under the second horizontal line based on compressibility of the image data of the second blocks.

2. The method of claim 1, wherein the generating the residual signal by predicting the image data of the second blocks comprises:
predicting the image data of the second blocks using image data of a plurality of reference pixels, wherein the pixels in a lowest line of the first blocks define the reference pixels; and
generating the residual signal based on difference of the predicted image data of the second blocks and the image data of the second blocks.

3. The method of claim 2, wherein
the reference pixels are the pixels disposed in the lowest line of a first upper block and in the lowest line of a first upper left block among the first blocks,
wherein the first upper block is a first block adjacent to a second block in an upper direction, and the first upper left block is a first block disposed at a left side of the first upper block.

4. The method of claim 3, wherein the predicting the image data of the second blocks using the image data of the reference pixels comprises using an average of the image data of the reference pixels.

5. The method of claim 3, wherein the predicting the image data of the second blocks using the image data of the reference pixels comprises:
predicting the image data of the pixels of the second block, which is disposed in a diagonal line to a right and lower direction from the reference pixels, as the image data of the reference pixels.

6. The method of claim 2, wherein
the reference pixels are the pixels disposed in the lowest line of a first upper block and in the lowest line of a first upper right block among the first blocks,
wherein the first upper block is a first block adjacent to a second block in an upper direction, and the first upper right block is a first block disposed at a right side of the first upper block, and
wherein the predicting the image data of the second blocks comprises:
predicting the image data of the pixels of the second block, which is disposed in a diagonal line to a left and lower direction from the reference pixels, as the image data of the reference pixels.

7. The method of claim 2, wherein
the reference pixels are the pixels disposed in the lowest line of a first upper block,
wherein the first upper block is a first block adjacent to a second block in an upper direction, and
wherein the predicting the image data of the second blocks comprises:
predicting the image data of the pixels of the second block, which is disposed in a lower direction from the reference pixels, as the image data of the corresponding reference pixels.

8. The method of claim 1, wherein the determining whether operating the discrete cosine transform to the residual signal or not comprises:
skipping the discrete cosine transform when the input image includes a specific pattern; and
operating the discrete cosine transform when the input image does not include the specific pattern.

9. The method of claim 8, wherein the compressing the image data of the second blocks comprises:
quantizing the residual signal in a frequency domain when the discrete cosine transform is operated; and
quantizing the residual signal in a time domain when the discrete cosine transform is skipped.

10. The method of claim 1, wherein the determining the compressibility of the image data of the third blocks comprises:
comparing the compressibility of the image data of the second blocks to a target compressibility; and
determining the compressibility of the image data of the third blocks based on a result of the comparing.

11. The method of claim 10, wherein the determining the compressibility of the image data of the third blocks based on the result of the comparing comprises:
decreasing the compressibility of the image data of the third blocks when the compressibility of the image data of the second blocks is greater than the target compressibility; and
increasing the compressibility of the image data of the third blocks when the compressibility of the image data of the second blocks is less than the target compressibility.

12. The method of claim 10, further comprising:
storing a parameter of the compressibility of the image data of the third blocks and the compressed image data of the second blocks to a memory.

13. The method of claim 12, wherein
the compressing the image data of the second blocks comprises quantizing the image data of the second blocks in a first quantizing coefficient,
wherein the parameter of the determined compressibility of the image data of the third blocks is a difference of the first quantizing coefficient and a second quantizing coefficient to achieve the determined compressibility of the image data of the third blocks, and
wherein the method further comprises:
quantizing the image data of the third blocks in the second quantizing coefficient to compress the image data of the third blocks.

14. The method of claim 1, wherein each of the blocks includes the pixels disposed in 4 rows and 4 columns.

15. A display apparatus comprising:
a display panel including a plurality of gate lines extending in a horizontal direction, a plurality of data lines extending in a vertical direction crossing the horizontal direction and a plurality of blocks, wherein each of the blocks includes a plurality of pixels arranged in pixel lines, and the display panel displays an image; and
a driver which predicts image data of a plurality of second blocks disposed in a second horizontal line using image data of a plurality of first blocks disposed in a first horizontal line to generate a residual signal,
wherein the second horizontal line is disposed under the first horizontal line, and
wherein the driver determines whether operating discrete cosine transform to the residual signal or not based on an input image, compresses the image data of the second blocks, and determines compressibility of image data of a plurality of third blocks disposed in a third horizontal line disposed under the second horizontal line based on compressibility of the image data of the second blocks.

16. The display apparatus of claim 15, wherein
the driver operates a dynamic capacitance compensation based on compressed previous frame image data and present frame image data to generate a present frame data signal, and
wherein the display panel displays a present frame image based on the present frame data signal.

17. The display apparatus of claim 15, wherein
the driver predicts the image data of the second blocks using image data of a plurality of reference pixels disposed in the lowest pixel line of the first blocks, and
the driver generates the residual signal based on difference of the predicted image data of the second blocks and the image data of the second blocks.

18. The display apparatus of claim 15, wherein
the driver skips the discrete cosine transform when the input image includes a specific pattern, and
the driver operates the discrete cosine transform when the input image does not include the specific pattern.

19. The display apparatus of claim 15, wherein
the driver compares the compressibility of the image data of the second blocks to a target compressibility, and
the driver determines the compressibility of the image data of the third blocks based on a result of comparing the compressibility of the image data of the second blocks to the target compressibility.

20. The display apparatus of claim 15, wherein the pixels in each of the blocks are disposed in 4 rows and 4 columns.
